(19) United States
(12) Patent Application Publication
(10) Pub. No.: US 2007/0294453 A1
(43) Pub. Date: Dec. 20, 2007

(54) PORTABLE ELECTRONIC DEVICE AND MULTIMEDIA SYSTEM

(75) Inventor: Fou-Ming Liou, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTEK COMPUTER INC., Taipei (TW)

(21) Appl. No.: 11/762,068

(22) Filed: Jun. 13, 2007

(30) Foreign Application Priority Data
Jun. 14, 2006 (TW) 95121194

(51) Int. Cl. G06F 13/00

(52) U.S. Cl. 710/303

(57) ABSTRACT

A portable electronic device suitable for being electrically connected to a multimedia expansion device and using the multimedia expansion device to control a multimedia output device is provided. The portable device includes a monitor and a host. The host is electrically connected to the monitor, and suitable for electrically connecting to the multimedia expansion device. The host includes a multimedia module and a switching module electrically connected thereto. When the monitor is turned off, the switching module turns the multimedia module off, and the host controls the multimedia output device through the multimedia expansion device. The present invention expands the multimedia functions of the portable device by using the multimedia expansion device, and turns off the monitor and transmits the multimedia signals to the multimedia expansion device by using the switching module. Therefore, the expansion of the multimedia functions of the portable device is simpler and more convenient.

### CROSS-REFERENCE TO RELATED APPLICATION

This application claims the priority benefit of Taiwan application serial no. 95121194, filed Jun. 14, 2006. All disclosure of the Taiwan application is incorporated herein by reference.

### BACKGROUND OF THE INVENTION

1. Field of the Invention

The present invention relates to a portable electronic device, and more particularly, to a portable electronic device with multimedia switching module.

2. Description of Related Art

With big advances in electronics technologies, the use of portable electronic devices such as notebook computers is increasingly common. The main difference between portable electronic devices and other non-portable types of electronic devices is that portable electronic devices aim for portability so that it must be designed to be as light and compact as possible. However, to reduce the volume of a portable electronic device so it is easier to carry, the performance of the portable electronic device is often limited to a level inferior to the non-portable counterpart.

For example, to enhance the portability of a notebook computer, built-in media devices such as a built-in sound effect chip and a built-in display chip are normally installed on the main board. Furthermore, due to volume consideration, additional expansion sockets for improving the performance of these multimedia devices are not normally installed. Thus, when the user needs to use high-grade software such as a 3D drafting software or 3D game software, the notebook computer may not have sufficient hardware capacity to execute the software or to execute the software smoothly. In other words, when the hardware of the portable electronic device does not have a sufficient performance capacity, the only solution is to switch to a higher-grade portable electronic device or to use a less portable electronic device but having a higher hardware performance capacity. However, to a portable electronic device user, the inability to expand the hardware not only leads to inconvenience, but also increases user's running cost.

It should be noted that the user might have to turn the system off before installing or exchanging a multimedia expansion card inside an electronic device such as a desktop computer or a notebook computer. Furthermore, when the electronic device has a plurality of identical function multimedia card such as a display card or a sound card, the user must get into the basic input/output system (BIOS) and change the multimedia card settings. Therefore, after expanding the electronic device, it further includes the additional difficulties and inconvenience to setting the multimedia card.

### SUMMARY OF THE INVENTION

Accordingly, at least one objective of the present invention is to provide an expandable portable device such that the hardware performance of the portable device can be improved through a multimedia expansion device.

At least another objective of the present invention is to provide a multimedia system with a switching module so that multimedia signal can be transmitted to a multimedia expansion device through turning a monitor off.

To achieve these and other advantages and in accordance with the purpose of the invention, as embodied and broadly described herein, the invention provides a portable device suitable for being electrically connected to a multimedia expansion device and using the multimedia expansion device to control a multimedia output device. The portable device includes a monitor and a host. The host is electrically connected to the monitor, and the host is suitable for being electrically connected to the multimedia expansion device. The host includes a multimedia module and a switching module, and the switching module is electrically connected to the multimedia module. When the monitor is turned off, the switching module turns the multimedia module off, and the host controls the multimedia output device through the multimedia expansion device.

In one embodiment of the present invention, the foregoing multimedia module includes a display card electrically connected to the monitor.

In one embodiment of the present invention, the foregoing multimedia module includes an sound card.

The present invention also provides a multimedia system including a multimedia output device, a multimedia expansion device and a portable device. The multimedia expansion device is electrically connected to the multimedia output device and the portable device is detachably and electrically connected to the multimedia expansion device. The portable device includes a monitor and a host. The host is electrically connected to the monitor and the host is detachably and electrically connected to the multimedia expansion device. The host includes a multimedia module and a switching module. Furthermore, the switching module is electrically connected to the multimedia module. When the monitor is turned off, the switching module turns the multimedia module off and the host controls the multimedia output device through the multimedia expansion device.

In another embodiment of the present invention, the foregoing multimedia module includes a first display card electrically connected to the monitor.

In another embodiment of the present invention, the foregoing multimedia output device includes an image output device, and the multimedia expansion device includes a video expansion unit electrically connected to the image output device.

In another embodiment of the present invention, the foregoing video expansion unit includes a second display card.

In another embodiment of the present invention, the foregoing video expansion unit further includes a physical acceleration card.

In another embodiment of the present invention, the foregoing multimedia module includes a first sound card.

In another embodiment of the present invention, the foregoing multimedia output device includes an sound effect output device and the multimedia expansion device includes an sound effect expansion unit electrically connected to the sound effect output device.

In another embodiment of the present invention, the foregoing sound effect expansion unit includes a second sound card.

In another embodiment of the present invention, the multimedia system further includes a docking station connected to the portable device.

In another embodiment of the present invention, the foregoing multimedia expansion device includes the functions of the multimedia module.

The present invention uses a multimedia expansion device to expand the multimedia function of the portable device and utilizes a switching module to turn off the monitor and transmit multimedia signal to the multimedia expansion device. Therefore, the expansion of multimedia functions of the portable device is simpler and more convenient.

It is understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a multimedia system according one embodiment of the present invention.

FIG. 2 is a diagram showing the turning on of the monitor of the multimedia system of FIG. 1.

FIG. 3 is a diagram showing the turning off of the monitor of the multimedia system of FIG. 1.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

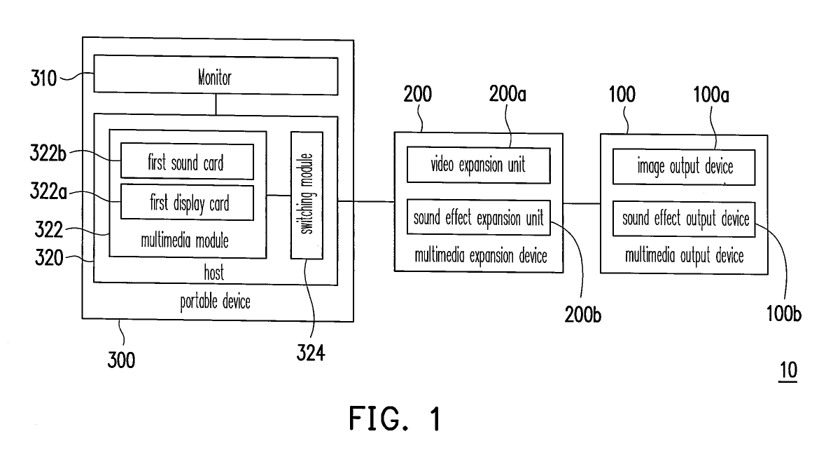

FIG. 1 is a block diagram of a multimedia system according one embodiment of the present invention. As shown in FIG. 1, the multimedia system 10 includes a multimedia output device 100, a multimedia expansion device 200 and a portable device 300. The portable device 300 includes a monitor 310 and a host 320. The host 320 is electrically connected to the monitor 310. The host 320 includes a multimedia module 322 and a switching module 324 and the switching module 324 is electrically connected to the multimedia module 322. Furthermore, the multimedia module 322 may include a first display card 322a and a first sound card 322b and the first display card 322a is electrically connected to the monitor 310. The first display card 322a and the first sound card 322b are, for example, originally built in the portable device. Moreover, the host 320 may further include a speaker (not shown) for emitting sound.

Continued as shown in FIG. 1, the multimedia expansion device 200 includes, for example, at least a video expansion unit 200a or a sound expansion unit 200b. The video expansion unit 200a includes, for example, a second display card, and the sound effect expansion unit 200b includes, for example, a second sound card. Furthermore, the portable device 300 is detachably and electrically connected to the multimedia expansion device 200. It should be noted that the hardware performance of the second display card and the second sound card might be higher than the first display card 322a and the first sound card 322b respectively to increase the multimedia function of the portable device 300.

In addition, the multimedia output device 100 includes, for example, at least an image output device 100a or an sound effect output device 100b. Moreover, the multimedia expansion device 200 is electrically connected to the multimedia output device 100. More specifically, when the multimedia expansion device 200 includes the video expansion unit 200a, the multimedia output device 100 also includes the image output device 100a and the video expansion unit 200a is electrically connected to the image output device 100a. Similarly, when the multimedia expansion device 200 includes the sound effect expansion unit 200b, the multimedia output device 100 also includes the sound effect output device 100b and the sound effect expansion unit 200b is electrically connected to the sound effect output device 100b.

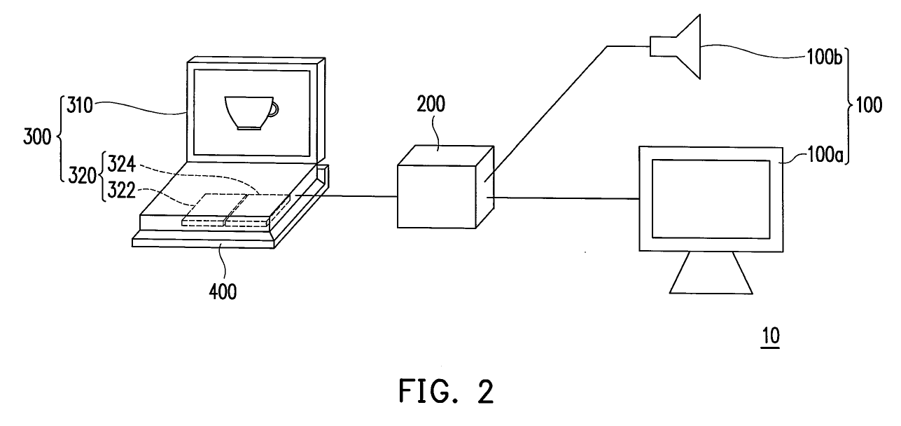

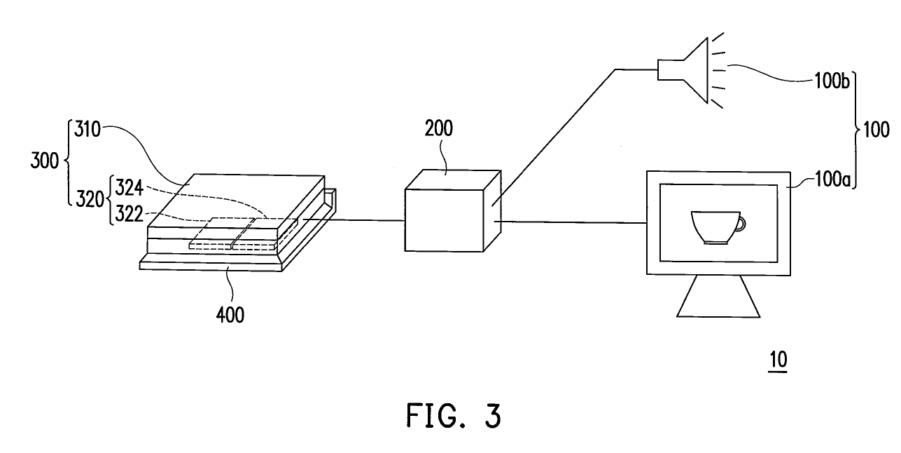

FIG. 2 is a diagram showing the turning on of the monitor of the multimedia system of FIG. 1. FIG. 3 is a diagram showing the turning off of the monitor of the multimedia system of FIG. 1. As shown in FIGS. 1 and 2, when the portable device 300 is activated and the monitor is turned on, the host 320 controls the monitor 310 and the speaker through the multimedia module 322. Furthermore, multimedia signal is transmitted to the monitor 310 and the speaker. The multimedia signal includes, for example, image signal or sound effect signal. Then, as shown in FIGS. 1 and 3, when the portable device 300 is activated and the monitor is turned off, the switching module 324 turns the multimedia module 322 off. Moreover, the host 320 controls the multimedia output device 100 through the multimedia expansion device 200. In the meantime, the multimedia signal is transmitted from the host 320 to the multimedia expansion device 200 and then transmitted to the multimedia output device 100.

More specifically, as shown in FIGS. 1 and 2, the multimedia expansion device 200 includes a video expansion unit 200a, and the multimedia output device 100 includes an image output device 100a. When the portable device 300 is activated and the monitor 310 is turned on, the host 320 controls the monitor 310 through the multimedia module 322, and image signal is transmitted to the monitor 310 to display image thereon. On the other hand, as shown in FIGS. 1 and 3, when the portable device 300 is activated and the monitor 310 is turned off, the switching module 324 turns the first display card 322a of the multimedia module 322 off. The host 320 controls the image output device 100a of the multimedia output device 100 through the video expansion unit 200a of the multimedia expansion device 200. In the meantime, image signal is transmitted from the host 320 to the video expansion unit 200a and then transmitted to the image output device 100a to display image on the image output device 100a. In addition, the video expansion unit 200a may simultaneously include a physical acceleration card (not shown) to increase the image signal processing speed of the video expansion unit 200a.

Similarly, as shown in FIGS. 1 and 2, the multimedia expansion device 200 may include an sound effect expansion unit 200b and the multimedia output device 100 may simultaneously include an sound effect output device 100b. When the portable device 300 is activated and the monitor 310 is turned on, the host 320 controls the speaker through the multimedia module 322 and sound signal is transmitted to the speaker to emit sound. Next, as shown in FIGS. 1 and 3, when the portable device 300 is activated and the monitor 310 is turned off, the switching module 324 also turns the first sound card 322b of the multimedia module 322 off. The host 320 controls the sound effect output device 100b of the multimedia output device 100 through the sound expansion unit 200b of the multimedia expansion device 200. In the meantime, sound signal from the host 320 is transmitted to the sound effect expansion unit 200b and then transmitted to the sound effect output device 100b to emit sound through the sound effect output device 100b.

As shown in FIG. 1, the multimedia output device 100 may simultaneously include an image output device 100a and an sound effect output device 100b. Moreover, the multimedia expansion device 200 may simultaneously include a video expansion unit 200a and a sound effect expansion unit 200b. The types of actions carried out are identical to ones in the foregoing description. More simply, the foregoing multimedia expansion device 200 may include at least the image signal processing function or the sound effect processing function of the multimedia module 322. Therefore, when the monitor 310 is turned off the multimedia expansion device 200 can be used to replace at least some of the functions of the multimedia module 322. In the meantime, multimedia signal is transmitted from the host 320 to the multimedia expansion device 200 and then transmitted to the multimedia output device 100 so that image can be displayed or sound can be emitted through the multimedia output device 100.

Again, as shown in FIGS. 2 and 3, the multimedia system 100 may further include a docking station 400 electrically connected to the portable device 300 to enhance the expansion function of the portable device 300. For example, a user may set up a connection with an external input device through the docking station 400. The input device is an externally connected input device such as an external mouse or an external keyboard. When the monitor 310 is turned off, the user can control the portable device 300 by controlling the externally connected input device.

In summary, because one of the characteristics of the multimedia expansion device in the present invention is a higher transmission rate, the hardware performance of the portable device can be raised through an externally connected multimedia expansion device. Furthermore, the present invention expands the hardware performance of the portable device through an external connection and there is no need to turn the system off while expanding the portable device. Thus, the present invention increases the convenience of expanding the portable device. In addition, under the condition of a multimedia expansion device externally connected to the portable device, the switching module automatically switches the multimedia signal and transmits the signal to the multimedia expansion device when the monitor is turned off. Therefore, after the expansion of the portable device, the user does not have to activate the system and enter the BIOS for changing the multimedia setting. As a result, the setting after expanding the portable device is simpler and more convenient.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A portable device suitable for being electrically connected to a multimedia expansion device and using the multimedia expansion device to control a multimedia output device, the portable device comprising:
a monitor;
a host, electrically connected to the monitor and suitable for being electrically connected to the multimedia expansion device, the host comprising:
a multimedia module; and
a switching module, electrically connected to the multimedia module, wherein, when the monitor is turned off, the switching module turns the multimedia module off and the host controls the multimedia output device through the multimedia expansion device.

2. The portable device of claim 1, wherein the multimedia module further comprises a display card electrically connected to the monitor.

3. The portable device of claim 1, wherein the multimedia module comprises a sound card.

4. A multimedia system, comprising:
a multimedia output device;
a multimedia expansion device, electrically connected to the multimedia output device;
a portable device, detachably and electrically connected to the multimedia expansion device, the portable device comprising:
a monitor;
a host, electrically connected to the monitor and detachably and electrically connected to the multimedia expansion device, the host comprising:
a multimedia module; and
a switching module, electrically connected to the multimedia module, wherein, when the monitor is turned off, the switching module turns the multimedia module off and the host controls the multimedia output device through the multimedia expansion device.

5. The multimedia system of claim 4, wherein the multimedia module comprises a first display card electrically connected to the monitor.

6. The multimedia system of claim 5, wherein the multimedia output device comprises an image output device and the multimedia expansion device comprises a video expansion unit electrically connected to the image output device.

7. The multimedia system of claim 6, wherein the video expansion unit comprises a second display card.

8. The multimedia system of claim 7, wherein the video expansion unit further comprises a physical acceleration card.

9. The multimedia system of claim 4, wherein the multimedia module comprises a first sound card.

10. The multimedia system of claim 9, wherein the multimedia output device comprises a sound effect output device and the multimedia expansion device comprises a sound effect expansion unit electrically connected to the sound effect output device.

11. The multimedia system of claim 10, wherein the sound effect expansion unit comprises a second sound card.

12. The multimedia system of claim 4, further comprising a docking station connected to the portable device.

13. The multimedia system of claim 4, wherein the multimedia expansion device comprises the functions of the multimedia module.
